(19) United States
(12) Patent Application Publication
(10) Pub. No.: US 2008/0191059 A1
(43) Pub. Date: Aug. 14, 2008

(54) SPRAY NOZZLE WITH INVERTED WATER FLOW

(76) Inventor: Samuel C. Walker, Green Valley, AZ (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/674,434

(22) Filed: Feb. 13, 2007

(51) Int. Cl. B05B 1/28

(52) U.S. Cl. 239/520

(57) ABSTRACT

A down flow spray nozzle is provided in which water is directed downwardly against one or more deflector surfaces for improved water distribution to terrain near to and distant from the nozzle. The nozzle is mounted to a water source and may include a nozzle base and a nozzle body having flow passages. Water flows upwardly into the flow passages of the nozzle base, upwardly through flow passages in the nozzle body into a chamber, and is redirected downwardly through other flow passages in the nozzle body. The water is directed downwardly against concave deflector surfaces in the nozzle base and outwardly to surrounding terrain.

### FIELD OF THE INVENTION

This invention relates to an irrigation spray nozzle and, more particularly, to a spray nozzle with an inverted water flow.

### BACKGROUND OF THE INVENTION

Irrigation nozzles have been adapted for mounting on a fixed or pop-up water supply riser. Spray type irrigation nozzles typically include at least one discharge orifice shaped to distribute water in a stream or spray pattern of a pre-selected arcuate span. One common form of such spray nozzle includes an upper deflector assembled to a lower nozzle body designed for mounting onto the riser. The deflector and nozzle body cooperatively define the discharge orifice with the selected arcuate span through which water is projected from the nozzle. Such spray nozzles commonly include a series of models that each produce a different spray pattern, such as, for example, a quarter-circle, half-circle, and full-circle spray pattern.

One shortcoming of many commercially available spray nozzles is their tendency to distribute water in a doughnut-shaped watering pattern caused by less water being distributed in the regions relatively close to and distant from the nozzle. In other words, such spray nozzles distribute most of the water to a mid-range region from the nozzle. This limited water distribution results from the arrangement between the upper deflector and the lower nozzle body. For example, water is directed upwardly from the lower nozzle body to impact the upper deflector. The deflector then redirects the water to the surrounding terrain.

In such commercially available spray nozzles, the water stream is generally comprised of two portions: an upper portion and a lower portion. The upper portion of the stream typically has a relatively low velocity because it has experienced frictional drag across the deflector. In contrast, the lower portion of the stream generally has a relatively high velocity because it has not experienced this frictional drag. As both water stream portions are emitted outwardly, gravity causes the lower velocity water to interfere with the higher velocity water, resulting in an intermediate velocity water stream that irrigates with only a mid-range doughnut pattern about the nozzle.

Accordingly, there is a need for a spray nozzle that reduces interference between low velocity and high velocity portions of the water stream. This would provide an enhanced distribution pattern by increasing the amount of water distributed to terrain outside of the limited mid-range distance, i.e., to terrain relatively near to, as well as terrain relatively distant from, the nozzle.

### BRIEF DESCRIPTION OF THE DRAWINGS

FIG. 1 is a perspective view of a spray nozzle embodying features of the present invention;

FIG. 2 is a cross-sectional view taken along line 2-2 of FIG. 1;

FIG. 3 is another cross-sectional view taken along line 3-3 of FIG. 1;

FIG. 4 is a perspective view of a nozzle base of the spray nozzle of FIG. 1;

FIG. 5 is a perspective view of a first embodiment of a nozzle body for the spray nozzle of FIG. 1;

FIG. 6 is a perspective view of a second embodiment of a nozzle body for the spray nozzle of FIG. 1;

FIG. 7 is a perspective view of a third embodiment of a nozzle body for the spray nozzle of FIG. 1;

FIG. 8 is a perspective view of a first embodiment of a cover for the spray nozzle of FIG. 1;

FIG. 9 is a perspective view of a second embodiment of a cover for the spray nozzle of FIG. 1;

FIG. 10 is a perspective view of a third embodiment of a cover for the spray nozzle of FIG. 1;

FIG. 11 is an exploded view of a side strip spray nozzle embodying features of the present invention;

FIG. 12 is a perspective view of a nozzle base for the side strip spray nozzle of FIG. 11;

FIG. 13 is a perspective view of a nozzle body for the side strip spray nozzle of FIG. 11;

FIG. 14 is a perspective view of a cover for the side strip spray nozzle of FIG. 11;

FIG. 15 is an exploded view of a corner strip spray nozzle embodying features of the present invention;

FIG. 16 is a perspective view of a nozzle base for the corner strip spray nozzle of FIG. 15;

FIG. 17 is a perspective view of a nozzle body for the corner strip spray nozzle of FIG. 15; and

FIG. 18 is a bottom view of a cover for the corner strip spray nozzle of FIG. 15.

### DESCRIPTION OF THE PREFERRED EMBODIMENT

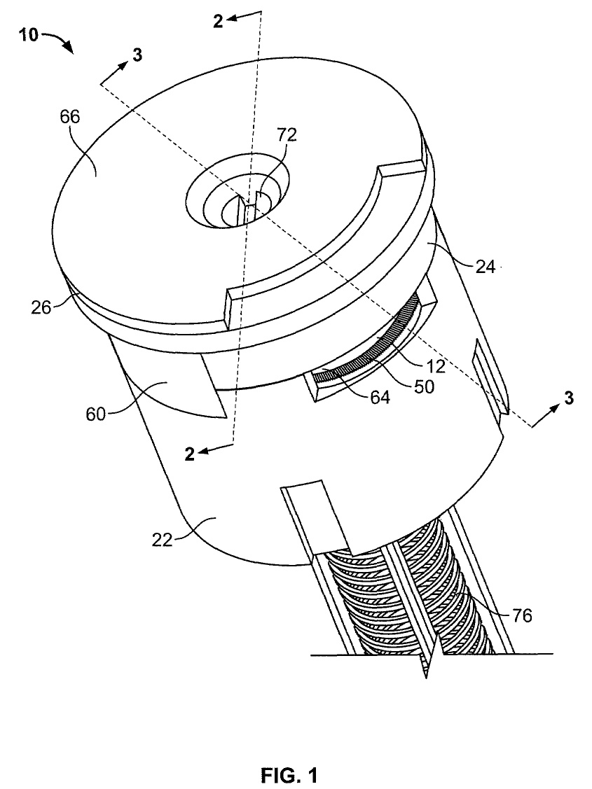

With reference to FIGS. 1-3, there is illustrated a preferred embodiment of a spray nozzle 10 embodying features of the present invention. The nozzle 10 improves the flow pattern at the inner and outer regions of the spray coverage by using a downward flow directed at a deflector 12 of the nozzle 10, as opposed to the upward flow at the deflector used in conventional spray nozzles. The inverted nature of the downward flow onto the deflector 12 results in a more uniform distribution of water, when compared to an upward flow nozzle, because the lower flow velocity component of the water discharging from the nozzle 10 cannot interfere directly with or fall into the higher velocity component. That is, the lower component is now at the bottom portion of the discharging water, and thus, the higher velocity component sprays generally above the lower velocity component. Consequently, the higher velocity component provides both a longer throw, which increases the watering area, and an improved watering at the outer region, and the lower velocity component waters the inner region more effectively.

In general, the inverted pattern is created by channeling the supply water first toward the top of the nozzle 10 and then back down to the deflector 12. That is, a series of upward flow passages 14 channels the water initially to a chamber 16 above the deflector 12. The water then flows from the chamber 16 through a series of downward flow passages 18 onto a top surface 20 of the deflector 12 to be redirected outward from the nozzle 10 for irrigation. Inverting the direction at the deflector 12 causes the high and low velocity components to switch as well.

More specifically, the nozzle 10 preferably includes a nozzle base 22, a nozzle body 24, and a nozzle cover 26, which, together, define the upward and downward flow passages 14 and 18, the chamber 16, and one or more deflector surfaces 20 of the nozzle 10. These components preferably are formed of a molded plastic material, or other suitable material, and although they are shown as three separate parts, they also may be combined to form one part or two parts.

With reference to FIG. 4, the nozzle base 22 is generally cylindrical in shape with a generally closed upper end 28 and an open lower mounting end 30. The lower mounting end 30 includes internal threading 32 for mounting of the nozzle 10 with corresponding external threading on an end of piping, such as a riser, supplying water. The nozzle base 22 also defines a central bore 34 to receive a flow throttling screw 36 to provide for adjustment of the inflow of water into the nozzle 10. Threading 38 is provided at the central bore 34 to cooperate with threading on the screw 36 to enable movement of the screw 36.

The upper end 28 of the nozzle base 22 also defines one or more flow passages 31 for the flow of water vertically upward from the water source and through the nozzle base 22. In this instance, there are four flow passages 31 with a circular cross-section and spaced circumferentially an equal distance from the ones directly adjacent thereto. The nozzle base 22 further includes one or more deflector surfaces 20. In this instance, there are four deflector surfaces 20 in between two flow passages 31 and spaced circumferentially an equal distance from the ones directly adjacent thereto. The flow passages 31 extend through seats 40 that define a top seating surface 42, which is elevated with respect to the deflector surfaces 20. Thus, the nozzle base 22 provides upward water flow and deflects water directed downward from the chamber 16 against the deflector surfaces 20 outward from the nozzle 10.

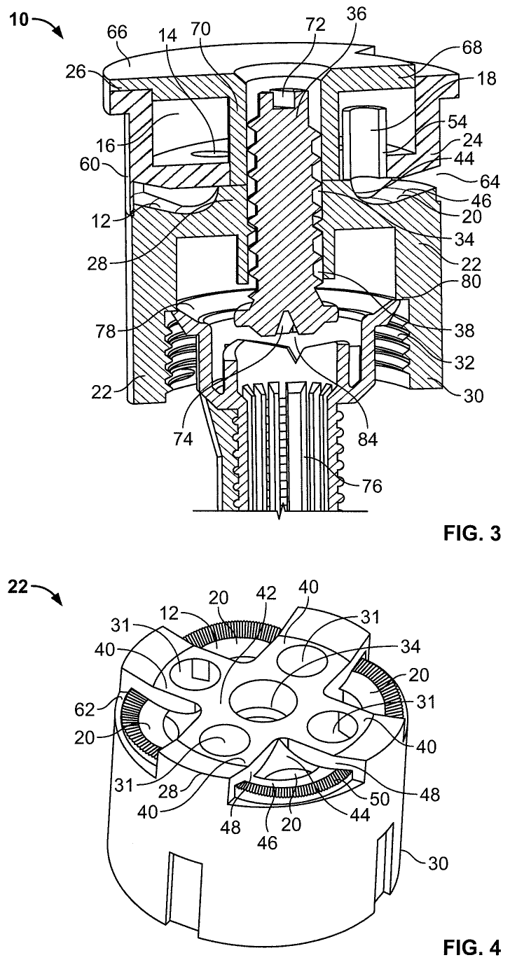

As illustrated in FIGS. 3 and 4, the deflector surfaces 20 are generally concave in shape in the radial direction. Each surface 20 includes an inner portion 44 and an outer portion 46. The inner portion 44 is closer to the central axis of the nozzle base 22 and has an outer perimeter defined by the intersection of the edges 48 of two adjacent raised seats 40. Moving radially outward, the inner portion 44 slopes relatively steeply downwardly to a nadir and, then, slopes relatively gently upwardly to transition into the outer portion 46. The outer portion 46 terminates with a number of radial extending drag-inducing grooves 50 about the outer periphery of the deflector surface 20. This concave geometry of the deflector surfaces 20 enhances uniform water distribution, as discussed further below.

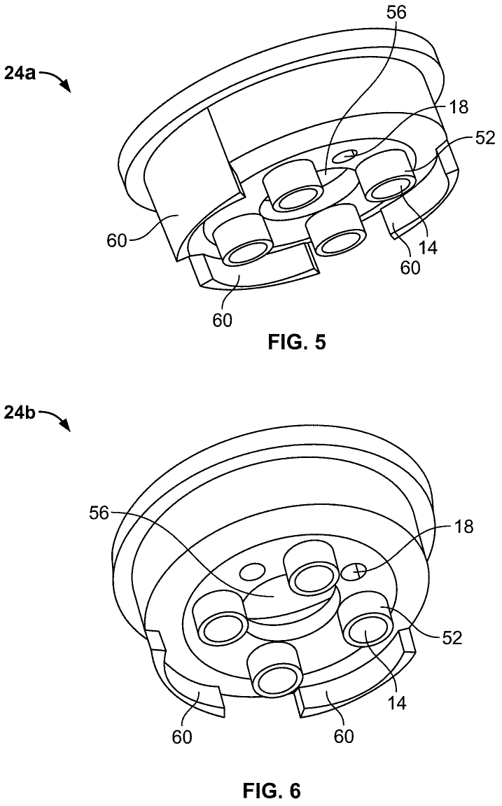

In FIGS. 5-7, there are illustrated three different forms of the nozzle body 24a, 24b, 24c. Each different nozzle body 24a-c produces an irrigation pattern for a different sized arcuate region. That is, nozzle body 24a (FIG. 5) produces 90 degree arc of coverage (quarter-circle); nozzle body 24b (FIG. 6) produces a 180 degree arc of coverage (half-circle); and nozzle body 24c (FIG. 7) produces a 360 degree arc of coverage (full-circle). Each nozzle body 24a-c preferably is generally cylindrical in shape and is seated vertically atop, and in fluid communication with, the nozzle base 22 and has two sets of flow passages: an upward set 14 for water flow upward through the nozzle body 24 and a downward set 18 for water flow downward through the nozzle body 24. The nozzle cover 26 and the nozzle body 24 together define the chamber 16, which places the upward flow passages 14 in fluid communication with the downward flow passages 18

The upward flow passages 14 are connected to the flow passages 31 of the nozzle base 22 so that water travels vertically upwardly from the nozzle base 22 through the flow passages 31 and, then, through the upward flow passages 14 to the chamber 16. In each of the nozzle bases 20a-c of FIGS. 5-7, there are four upward flow passages 14 that have a circular cross-section with an outer diameter slightly less than the inner diameter of the circular cross-section of the flow passages 31 of the nozzle base 22. Each of the upward flow passages 14 is tube-like and extends into one of the flow passages 31 with the outer surface of the tube 52 engaging the inner surface of the flow passage 31 to form a sealed connection.

As illustrated in FIGS. 5-7, the number of downward flow passages 18 corresponds to the size of the desired water distribution arc. For example, the nozzle body 24a of FIG. 5 (quarter-circle) defines one downward flow passage 18; the nozzle body 24b of FIG. 6 (half-circle) defines two downward flow passages 18; and the nozzle body 24c of FIG. 7 (full-circle) defines four downward flow passages 18.

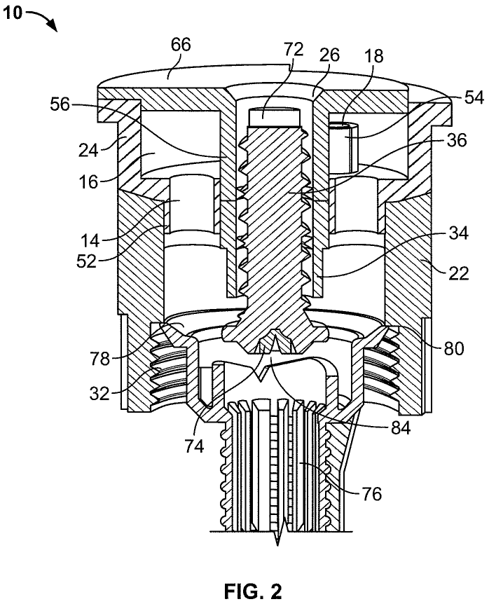

With reference to FIGS. 2 and 3, each of the downward flow passages 18 is defined by an upwardly projecting cylindrical tube 54 that is positioned above and vertically spaced from one of the deflector surfaces 20 of the nozzle base 22. The tubes 54 function to direct water downwardly against the respective deflector surfaces 20 to reduce or eliminate tangential components of flow as compared to a mere opening without the tube portion. Tangential components of flow, i.e., flows that impact the deflector surfaces 12 at one or more of a range of angles different than generally vertical, can disadvantageously result in interfering water streams and a non-uniform distribution of water at different distances from the nozzle 10. Each nozzle body 24a-c defines a central opening 56 therethrough which cooperates with a cover 26, as described further below.

Each nozzle body 24a-b includes one or more arcuate tabs 60 that project downward from a portion of the outer periphery of the nozzle body 24a-b. Each tab 60 engages a landing 62 formed at the outer periphery of each deflector surface 20 between adjacent seats 40. The number and arrangement of arcuate tabs 60 indicate the nature of the nozzle 10, i.e., the three tabs 60 of nozzle body 24a of FIG. 5 corresponds to a quarter-circle nozzle, the two tabs 60 of the nozzle body 24b of FIG. 6 corresponds to a half-circle nozzle, and the lack of any tabs on the nozzle body 24c of FIG. 7 corresponds to a full-circle nozzle. The arcuate tabs 60 also indicate the direction of spray from the nozzle 10 by eliminating the arcuate gap 64 between the nozzle base 22 and the nozzle body 24 at deflector surfaces 20 where water is not being emitted.

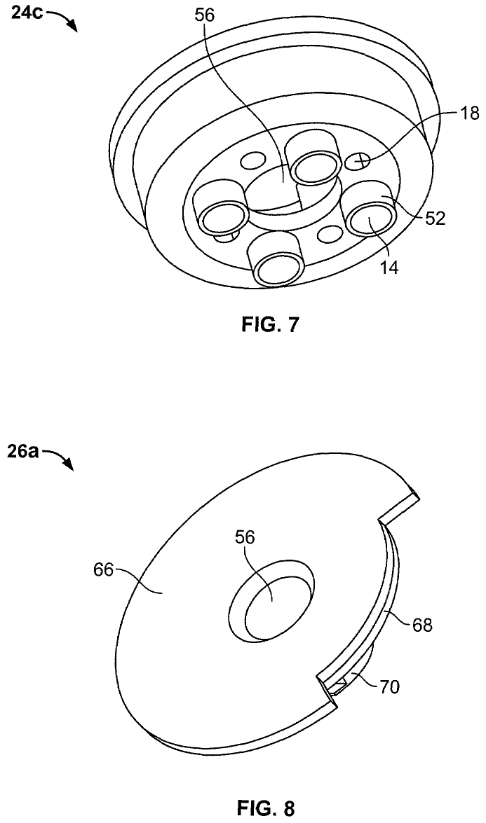

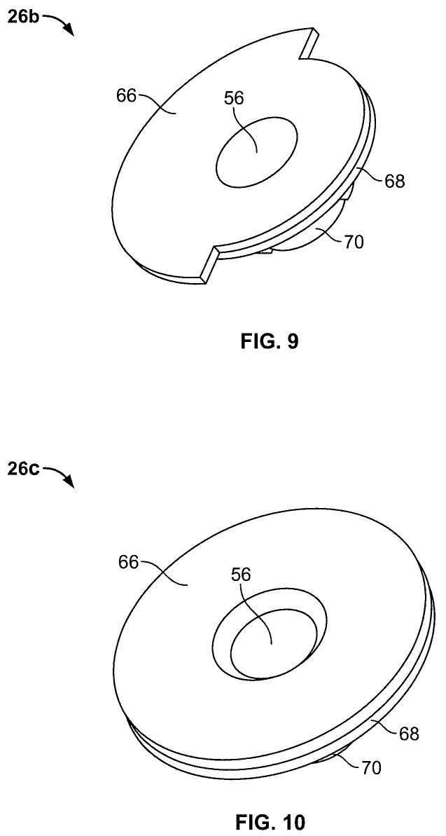

In FIGS. 8-10, there are illustrated three different preferred embodiments of the cover 26a-c. Each cover 26 includes a disk-like top surface 66 that indicates the nature of the nozzle 10, i.e., quarter (FIG. 8), half (FIG. 9), or full (FIG. 10), and the direction of spray from the nozzle 10. For example, the cover 26a of FIG. 8 has approximately one-fourth of the outer circumference of the top surface 66 indented with a reduced diameter, indicating that the nozzle 10 is a quarter-circle nozzle and indicating that spray is in the direction of the indented portion. Similarly, the cover 26b of FIG. 9 has about one-half of the outer circumference of the top surface 66 indented, thereby identifying the nature of the nozzle 10 and where spray will be emitted from the nozzle 10. The cover 26c of FIG. 10 has the entire outer circumference of the top surface 66 indented with a reduced diameter, identifying the nozzle 10 as a full-circle nozzle and indicating that spray is emitted in the full 360 degrees of arc.

As shown in FIGS. 2 and 3, the cover 26 sits on top of the nozzle body 24. The cover 26 cooperates with the nozzle body 24 to define the chamber 16. As mentioned above, the chamber 16 places the upward flow passages 14 in fluid communication with the downward flow passages 18. The cover 26 includes an annular top plate 68 and a central hub 70 projecting downwardly from the plate 68. The central hub 70 extends through the opening 56 defined by the nozzle body 24 and engages the nozzle base 22 about the central bore 34 of the nozzle base 22.

The flow throttling screw 36 extends through the central hub 70 and the central bore 34 of the cover 26 and the nozzle base 22, respectively. The flow throttling screw 36 is manually adjusted to throttle the flow of water through the nozzle 10. The throttling screw 36, includes a head 72, is seated in the central hub 70 of the cover 26 and may be adjusted through the use of a hand tool. The opposite end 74 of the screw 36 is in proximity to an inflow port 84 protected from debris by a filter 76. Rotation of the head 72 results in translation of the opposite end 74 for regulation of water inflow into the nozzle 10. The screw 36 may be rotated in one direction to decrease the inflow of water into the nozzle 10, and in the other to increase the inflow of water into the nozzle 10.

The filter 76 includes an upper lip 78 for mounting the filter 76 to an annular inner surface 80 of the nozzle base 22. The lip 78 is adapted for press fit or slide fit reception onto the inner surface 80 of the base 22. The filter 76 is located upstream of the flow passages, chambers, and deflectors of the nozzle 10 and restricts grit and other debris from flowing into the nozzle 10 and becoming lodged in areas that may cause the operation of the nozzle 10 to be hindered.

When water is supplied to the nozzle 10, it flows upwardly through the filter 76 and then upwardly through the flow passages 31 of the nozzle base 22. Next, water flows upwardly through the upward set of flow passages 14 of the nozzle body 24 and into the chamber 16. Water is then redirected downwardly through the downward set of flow passages 18 of the nozzle body 24, to impact on one or more of the deflector surfaces 20 of the nozzle base 22 to be redirected outwardly from the nozzle 10 for irrigation.

The down flow approach to the deflector 12 of the nozzle 10 results in an inverted velocity profile in the water leaving the deflector surface 20 in comparison to the conventional up flow approach to the deflector. The inverted water velocity profile produces a more uniform distribution of water to surrounding terrain because high velocity water is in the upper region of the profile and the lower velocity water is in the lower region of the profile, and therefore, they do not directly interfere with one another.

More specifically, in conventional spray nozzles, the water is directed upward to the deflector for deflection outward from the nozzle. The surface drag on the deflector results in low velocity water leaving the nozzle in the upper region of the profile, and higher velocity water leaving the nozzle in the lower region of the profile. Gravity then causes the lower velocity water to fall into the higher velocity water. This interference creates a compressed profile of a mid-range velocity which causes the water to carry over the desired watering area close to the nozzle and to fall short of the desired watering area furthest from the nozzle. As a result, a doughnut shaped distribution pattern around the nozzle is formed with water distributed primarily to a limited mid-range distance from the nozzle.

In contrast, the water deflected from the deflector surfaces 20 of the deflector 12 of the nozzle 10 does not interfere in this manner, resulting in a more uniform water distribution pattern. The limitation on interference is produced by the inverted flow profile. With the deflector surface 20 at the bottom of the water profile, the lower velocity flow created by the drag across the deflector surface is on the bottom portion of the profile, whereas the higher velocity water is overhead and above. Thus, lower velocity water will not tend to interfere with the higher velocity water.

In addition, the outer annular region of each deflector surface 20 is formed with radially extending grooves 50 to increase the surface area of the deflector surface 20 at the outermost region. The grooves 50 increase the frictional drag on the water across the deflector surface 20 to further reduce the velocity of the water at the bottom of the profile leaving the deflector 12. This enhances the water distribution for the area closer to the nozzle 10, while allowing the higher velocity water of the upper portion of the profile to reach the outermost area desired to be watered by the nozzle 10.

The characteristics of the water discharge profile may be tailored by changing certain aspects of the nozzle 10. For example, although four upward flow passages 14 are shown in FIGS. 5-7, other embodiments of the nozzle body 24 may use other numbers and arrangements of upward flow passages 14. The numbers and arrangements of downward flow passages 18 through the nozzle body 24 also may be modified. In addition, the number and arrangement of grooves 50, or other alternative surface features, may be modified to increase or decrease the frictional drag across the deflector surfaces 20 and to thereby increase or decrease the velocity of different portions of the velocity profile of the water emitted from the deflector surfaces 20.

The flow characteristics of the water emitted from the nozzle 10 may be modified for different models by changing certain dimensions of the nozzle 10, such as, for example, the cross-sectional dimension of the upward and downward flow passages 14 and 18. The diameter of each upward flow passage 14 may be different than the diameter of each downward flow passage 18. The ratio of these diameters may be adjusted to achieve desirable water pressure and velocity values at the deflector surfaces 20 of the nozzle base 22. The use of two orifices in series provides significant advantages over nozzles having only one orifice.

For example, the cross-sectional diameter of the upward flow passages 14 may be selected so that the diameter is relatively large compared to that of the downward flow passages 18. When the ratio of these diameters is relatively large, the pressure at the downward flow passages 18 and the velocity of the emitted water are also relatively large. In other words, the use of upward flow passages 14 with relatively large diameters results in a relatively insignificant loss of water pressure and velocity for water flowing through the nozzle 10.

The diameters of the upward and downward flow passages 14 and 18 may be modified for different models. As the ratio of the diameters is modified, the flow characteristics of the nozzle 10 are changed. More specifically, as the ratio is reduced, the pressure at the downward flow passages 18 and the velocity of the emitted water is correspondingly reduced. In other words, as the diameter of the upward flow passages 14 are made narrower relative to the downward flow passages 18, water flowing through the nozzle 10 experiences a significant loss of pressure and velocity. Accordingly, manufacturing nozzles having different flow passage diameters allows for the control of desired pressure and velocity characteristics.

In this manner, it is possible to design a family of nozzles with different throw radiuses that have the same precipitation rate, i.e., the same quantity of emitted water for a given unit of area and time. For instance, it may be desired to have a nozzle with a 16 foot radius and a nozzle with an 8 foot radius with both nozzles having the same precipitation rate. Assuming predetermined cross-sectional areas for the upward and downward flow passages of the 16 foot nozzle (A₁₄ and A₁₈) for a desired arc, trajectory, and operating pressure, appropriate values for the cross-sectional areas of the upward and downward flow passages of the 8 foot nozzle (B₁₄ and B₁₈) may be calculated by applying principles of flow dynamics.

These values may be calculated in three steps. First, to reduce the throw radius in half, the velocity of water emitted from the 8 foot nozzle is reduced in half relative to the 16 foot nozzle. Second, in order to achieve a matched precipitation rate for the 8 foot nozzle having this reduced velocity, the cross-sectional area of the downward flow passage of the 8 foot nozzle, B₁₈, must be half that of the 16 foot nozzle, A₁₈, i.e., B₁₈=0.5*A₁₈. Third, the velocity of water emitted from the 8 foot nozzle is reduced in half by designing the 8 foot nozzle with the appropriate pressure-reducing ratio of (B₁₄/B₁₈)=1/SQRT (3)=0.58. In other words, the 16 foot and 8 foot nozzles may be designed with matching precipitation rates by designing the nozzles such that B₁₈=0.5*A₁₈=1.73*B₁₄. Similar calculations may be performed to design other nozzle types having different throw radiuses but having the same precipitation rate.

The use of nozzles having flow passages 14 and 18 in series (rather than a single flow passage) provides additional advantages, including the ability to control and reduce exit velocities of emitted water. Reduced exit velocities limit the undesirable effect known as “misting.” High exit velocities cause relatively high levels of internal turbulence within the emitted water stream and cause the water stream to experience relatively greater shear forces from the surrounding air. These combined effects tend to tear smaller droplets from the emitted water stream, i.e., to cause the emitted water stream to mist. In turn, this results in high evaporation rates and wind drift, both of which reduce irrigation efficiency.

Further, the upward and downward flow passages 14 and 18 can be substantially larger in diameter than a single orifice (such as that used in a conventional up flow nozzle). For nozzles 10 with orifices in series, the ratio of the orifice size affects pressure and exit velocity characteristics. For single orifice nozzles, in contrast, these characteristics may often be determined by the size of the single orifice and may require that the single orifice be very small. Accordingly, the use of relatively large orifices in series reduces the sensitivity of nozzles to clogging with contamination that would otherwise occur in conventional nozzles employing a relatively small single orifice.

Water flow characteristics may be modified in other ways. For instance, one or more of the upward flow passages 14 of the nozzle body 24 may be plugged or blocked to match the number of open upward and downward flow passages of the nozzle body 24, thereby achieving desired pressure and velocity values. By way of example, the quarter-circle nozzle body 24a shown in FIG. 5 may have three of the upward flow passages 14 obstructed so that only one upward and one downward flow passage are open. Similarly, with respect to the half-circle nozzle body 24b of FIG. 6, two of the upward flow passages 14 may be obstructed so that two upward and two downward flow passages are open. These sorts of adjustments allow fine tuning of the nozzle 10 so that it exhibits desired pressure and velocity characteristics.

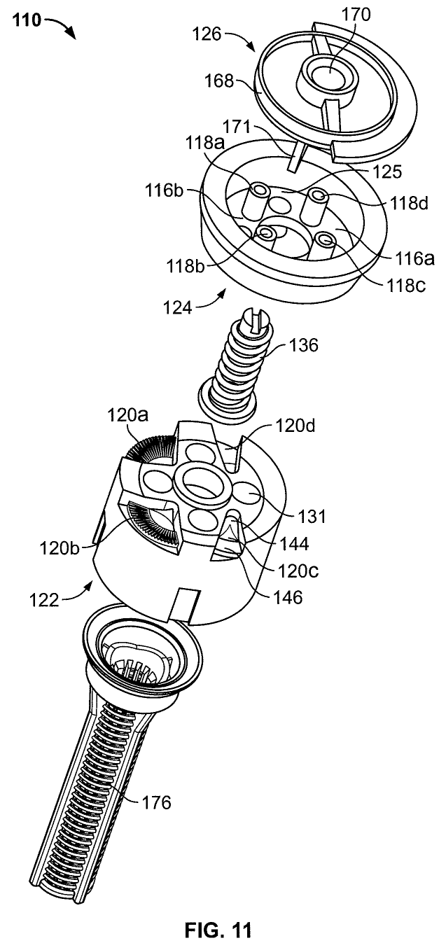

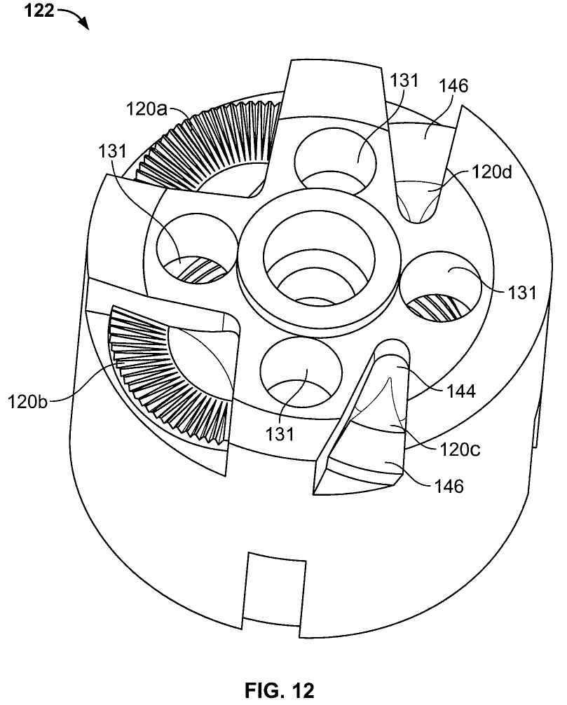

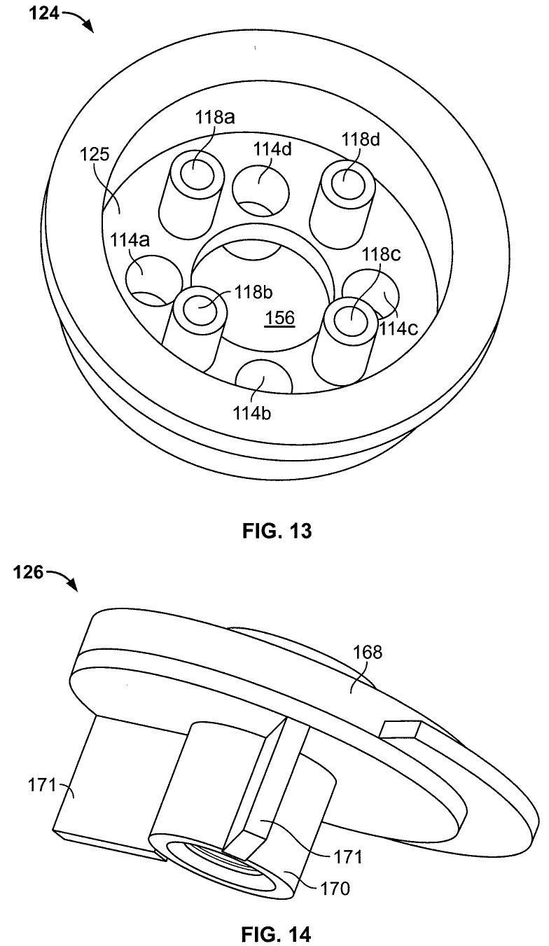

In FIG. 11, there is illustrated another embodiment of a nozzle 110. Nozzle 110 is a side strip specialty nozzle that has a different distance of throw for two or more outlets and allows watering of a relatively long narrow strip to each side of the nozzle 110. The nozzle 110 preferably includes a nozzle base 122 (FIG. 12), a nozzle body 124 (FIG. 13), a nozzle cover 126 (FIG. 14), and a flow throttling screw 136 (FIG. 11). Water flow through the nozzle 110 is similar to that described above, i.e., water flows upward through the filter 176, upward through the upward flow passages 131, upward through the upward flow passages 114, downward through the downward set of flow passages 118, onto the deflector surfaces 120, and radially outwardly from the nozzle 110 for irrigation.

As shown in FIG. 12, the nozzle base 122 has four deflector surfaces 120a-d, comprising two sets having different shapes. The first set 120a-b is similar in shape to the deflector surfaces 20 described above. These two deflector surfaces 120a-b provide coverage for a relatively close in watering area, such as for example a 4′ by 6′ area, to each side of the nozzle 110.

The deflector surfaces 120c-d each define a relatively narrow and elongated flow channel compared to the first set. The deflector surfaces 120c-d each include an inner portion 144 that slopes relatively steeply downwardly to a nadir and, then, slopes relatively gently upwardly to transition into an outer portion 146. The sides of the deflector surfaces 120c-d define a relatively acute angle compared to the first set 120a-b. The deflector surfaces 120c-d are oriented non-radially to direct water to each side of the nozzle 110 beyond the close in area of coverage of the first set 120a-b. Thus, for example, the second set of deflector surfaces 120c-d each distribute water to a relatively distant area, such as between a 4′ by 6′ area and a 4′ by 15′ area, on opposite sides. Taken together, the deflector surfaces 120a-d provide continuous coverage for a 4′ by 15′ long narrow strip on each side of the nozzle 110.

As shown in FIG. 13, the nozzle body 124 is similar in shape to the one described above and shown in FIG. 7. The nozzle body 124 has four upward flow passages 114 and four downward flow passages 118, and water flows through these flow passages 114 and 118 in the manner described above. The nozzle body 124 has an annular central plate 125 that defines eight circumferentially spaced openings, corresponding to each of the flow passages 114 and 118, and that also defines a central opening 156 therethrough.

As shown in FIG. 14, the nozzle cover 126 includes a top plate 168, a central hub 170 projecting downwardly from the top plate 168, and two barrier walls 171 projecting downwardly from the top plate 168. When the nozzle 110 is assembled, the barrier walls 171 of the nozzle cover 126 sit on top of annular central plate 125 of the nozzle body 124. The cover 126 thereby cooperates with the nozzle body 124 to define two chambers 116a-b of different sizes.

The barrier walls 171 are positioned so that three of the upward flow passages 114b-d feed into chamber 116a, the larger chamber. The barrier walls 171 are also positioned so that two of the downward flow passages 118c-d extend into chamber 116a. These two downward flow passages 118c-d lie above deflector surfaces 120c-d, and, during operation, direct water downwardly against these surfaces. By orienting the barrier walls 171 to include three of the upward flow passages 114b-d, water flowing onto deflector surfaces 120c-d experiences relatively high pressure and velocity, thereby allowing distribution of water relatively distant from the nozzle 110.

In contrast, the barrier walls 171 are positioned so that only one of the upward flow passages 114a feeds into chamber 116b, the smaller chamber. During operation, water flows through the one upward flow passage 114a, into chamber 116b, through the two downward flow passages 118a-b, and onto deflector surfaces 120a-b. By orienting the barrier walls 171 to include only one of the upward flow passages 114a, water flowing onto deflector surfaces 120a-b experiences relatively low pressure and velocity, thereby allowing distribution of water relatively close to the nozzle 110. Thus, barrier walls 171 may be used to isolate one or more upward and downward flow passages 114 and 118 from others to provide different throw distances for the different deflector surfaces120a-d.

Adjustments, such as those described above, may be made to allow fine tuning of the nozzle 110 so that it exhibits desired pressure and velocity characteristics. For example, the cross-sectional areas of the upward and downward flow passages 114 and 118 may be varied to alter pressure, velocity, and throw distance, as desired.

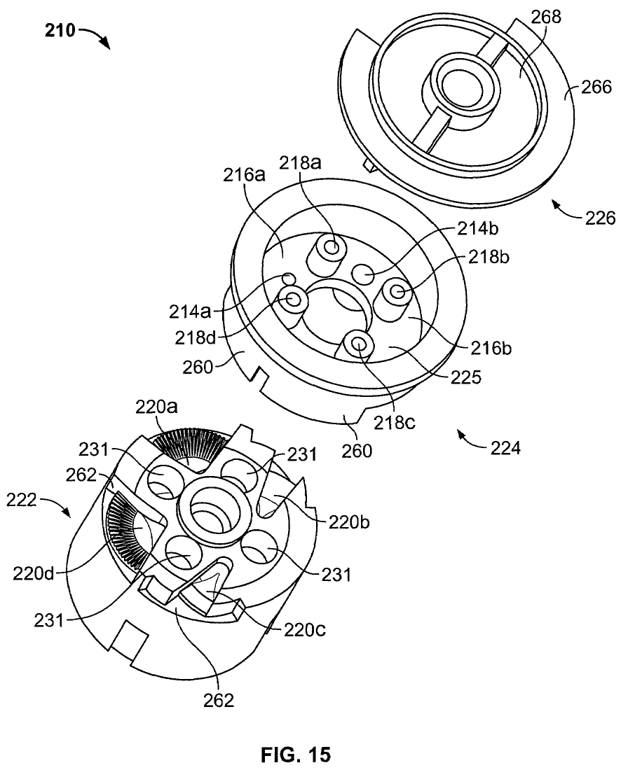

FIG. 15 shows another embodiment of a nozzle 210. Nozzle 210 is a corner strip specialty nozzle that disperses water through two outlets and has a different distance of throw for each of the two outlets. Corner strip nozzle 210 operates in a manner similar to the side strip nozzle 110 described above but allows irrigation of a relatively long and narrow area to one predetermined side of the nozzle 210.

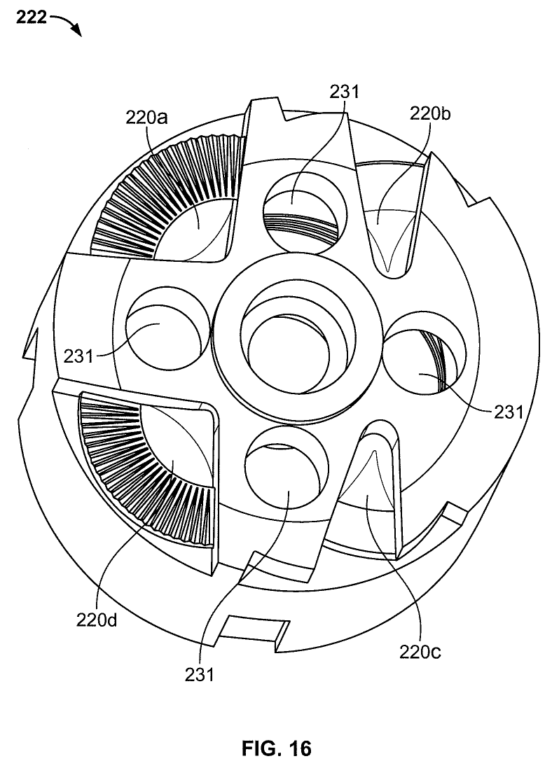

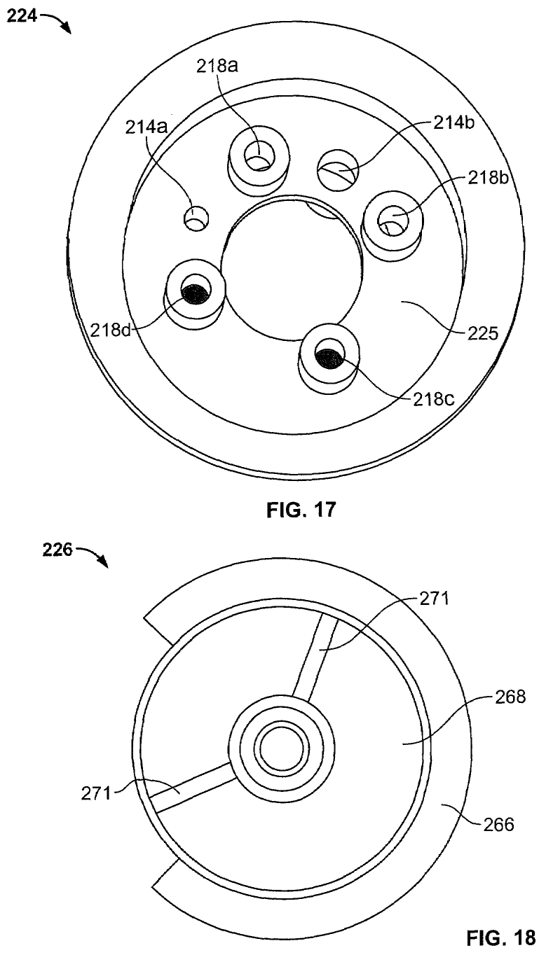

Like the side strip nozzle 110, the corner strip nozzle 210 preferably includes a nozzle base 222 (FIG. 16), a nozzle body 224 (FIG. 17), a nozzle cover 226 (FIG. 18), and a flow throttling screw (not shown). Unlike the side strip nozzle 110, however, the corner strip nozzle 210 shown in FIG. 15 only allows fluid flow through two upward flow passages 214a and 214b and through two downward flow passages 218a and 218b, as described below. Water flow through the corner strip nozzle 210 is generally as follows: water flows upward through a filter (not shown), upward through nozzle base flow passages 231, upward through two upward flow passages 214a and 214b, downward through two downward flow passages 218a and 218b, onto two deflector surfaces 220a and 220b, and radially outwardly to one side of the nozzle 210.

As shown in FIG. 16, the corner strip nozzle 210 preferably uses a similar nozzle base 222 as used for the side strip nozzle 110, so that the nozzle base 222 may be used interchangeably with either nozzle type. The nozzle base 222 includes four deflector surfaces 220a-d, comprising two relatively wedge-shaped deflector surfaces 220a and 220d and two relatively elongated deflector surfaces 220b and 220c, which are described in more detail above. During operation, however, unlike the side strip nozzle 110, water is only deflected onto the two deflector surfaces 220a and 220b to distribute water to one side of the nozzle 210.

As shown in FIG. 17, the nozzle body 224 of the corner strip nozzle 210 has two upward flow passages 214a and 214b and two open downward flow passages 218a and 218b. The other two downward flow passages 218c and 218d shown in FIG. 17 are obstructed. As can be seen in FIG. 17, the upward flow passage 214a has a different diameter size than that of upward flow passage 214b, i.e., it is smaller in diameter than passage 214b. As described further below, the nozzle body 224 may be designed so as to include upward flow passages 214a and 214b having different predetermined diameter sizes, depending on the desired flow characteristics of the nozzle 210.

As shown in FIG. 15, the nozzle body 224 also preferably includes two arcuate tabs 260 that project downwardly from a portion of the outer periphery of the nozzle body 224. Each of these two tabs 260 engages a landing 262 formed at the outer periphery of the two deflector surfaces 220c and 220d. The two arcuate tabs 260 indicate the nature of the nozzle, i.e., corner strip rather than side strip. They also indicate the direction of spray from the nozzle 210 by hiding the deflector surfaces 220c and 220d from external view and thereby revealing only the deflector surfaces 220a and 220b from which water will be emitted.

The nozzle cover 226 of the corner strip nozzle 210 is shown in FIG. 18. As with the side strip nozzle 110, the nozzle cover 226 includes two barrier walls 271 that are used to define flow chambers. More specifically, as can be seen from FIG. 15, when the corner strip nozzle 210 is assembled, the barrier walls 271 project downwardly from the top plate 268 of the nozzle cover 226 to engage the annual central plate 225 of the nozzle body 224. The barrier walls 271, top plate 268, and annular central plate 225 cooperate to form two chambers 216a and 216b of different sizes. The nozzle cover 226 also preferably includes a top surface 266 having a portion of the outer circumference indented to indicate the general direction of spray from the corner strip nozzle 210.

The barrier walls 271 are oriented so that one upward and one downward flow passage correspond to each chamber. More specifically, one upward flow passage 214a feeds into, and one downward flow passage 218a extends into, chamber 216a, the smaller chamber. Similarly, the other upward and downward flow passages 214b and 218b feed and extend into, respectively, chamber 216b, the larger chamber. The downward flow passages 218a and 218b are situated above deflector surfaces 220a and 220b and direct water downwardly onto these deflector surfaces.

The barrier walls 271 are oriented so that the upward flow passage with the smaller orifice size, 214a, feeds into the smaller chamber 216a, and conversely, so that the upward flow passage with the larger orifice size, 214b, feeds into the larger chamber 216b. By designing chamber size and orifice size in this manner, water flowing onto the relatively elongated deflector surface 220b experiences relatively high pressure and velocity for distribution of water relatively distant from the nozzle 210, while water flowing onto the relatively wedge-shaped deflector surface 220a experiences relatively low pressure and velocity for distribution of water relatively close to the nozzle 210.

FIG. 15 shows one embodiment of a corner strip nozzle 210. The dimensions may be modified to create other embodiments having desired flow characteristics. More specifically, it should be evident that the chamber size and the orifice size of the upward flow passages 214a and 214b may be modified as desired to achieve different flow characteristics, i.e., different pressures, velocities, and throw distances. Further, it should be evident that different numbers and arrangements of upward and downward flow passages 214 and 218 may also be modified to achieve desired flow characteristics.

The foregoing relates to preferred exemplary embodiments of the invention. It is understood that other embodiments and variants are possible which lie within the spirit and scope of the invention as set forth in the following claims.

1. A spray nozzle comprising:
at least one primary deflector surface to deflect fluid from the spray nozzle with an emission profile comprising fluid with a first velocity at a top portion of the profile and fluid with a second velocity at a bottom portion of the profile, the first velocity being greater than the second velocity such that fluid having the first velocity does not interfere with fluid having the second velocity; and
a flow path that fluid follows from below the at least one primary deflector surface to downward onto the at least one primary deflector surface for deflection.

2. The spray nozzle of claim 1 wherein the flow path comprises at least two different cross-section dimensions therealong depending on the desired emission profile.

3. The spray nozzle of claim 2 wherein the at least two different cross-section dimensions are selected to yield a predetermined fluid precipitation rate for the spray nozzle.

4. The spray nozzle of claim 1 wherein the at least one primary deflector surface has an uneven surface profile to increase frictional drag at the at least one primary deflector surface to lower the second velocity.

5. The spray nozzle of claim 1 further comprising:
a nozzle base having a lower portion adapted for coupling to a source of pressurized fluid; and
a nozzle body in fluid communication with the nozzle base such that the nozzle base and the nozzle body define at least in part the flow path.

6. The spray nozzle of claim 5 wherein the nozzle base has at least one first upward flow passage and the nozzle body has at least one second upward flow passage in fluid communication with the at least one first upward flow passage to define at least in part the flow path.

7. The spray nozzle of claim 6 wherein the nozzle body has at least one downward flow passage defining at least in part the flow path for directing fluid onto the primary deflector surface.

8. The spray nozzle of claim 7 wherein the nozzle body has a chamber forming a portion of the fluid path between the at least one second upward flow passage and the at least one downward flow passage.

9. The spray nozzle of claim 8 wherein the flow path comprises at least two different cross-section dimensions with at least one dimension upstream of the chamber and another dimension downstream of the chamber.

10. The spray nozzle of claim 8 wherein the at least one downward flow passage includes a conduit projecting into the chamber that defines at least in part the flow path.

11. The spray nozzle of claim 10 wherein the at least one second upward flow passage includes a conduit that is received at least in part in the at least one first upward flow passage.

12. The spray nozzle of claim 11 further comprising a flow control adjustment member.

13. The spray nozzle of claim 11 further comprising a filter upstream of the flow path.

14. The spray nozzle of claim 11 wherein the at least one primary deflector surface has an uneven profile to increase frictional drag at the at least one primary deflector surface to lower the second velocity.

15. The spray nozzle of claim 14 wherein the at least one primary deflector surface has a plurality of generally radially extending grooves to provide the uneven profile.

16. The spray nozzle of claim 8 wherein the at least one downward flow passage includes at least two downward flow passages and the at least one primary deflector surface includes at least two primary deflector surfaces and each downward flow passage corresponds with one of the at least two primary deflector surfaces to direct fluid onto the respective primary deflector surface.

17. The spray nozzle of claim 16 wherein the at least one second upward flow passage includes at least two upward flow passages, each upward flow passage corresponding to one of the at least two downward flow passages, and at least one barrier wall subdividing the chamber into at least two sub-chambers.

18. The spray nozzle of claim 17 wherein the at least one barrier wall subdivides the chamber into two sub-chambers, the first sub-chamber configured to receive fluid from one or more upward flow passages and the second sub-chamber configured to receive fluid from one or more upward flow passages.

19. The spray nozzle of claim 18 wherein the at least one primary deflector surface includes two sets of deflector surfaces, each set including one or more deflector surfaces, the first set in fluid communication with the first sub-chamber and the second set in fluid communication with the second sub-chamber, the first set of deflector surfaces configured to deflect fluid relatively distant from the spray nozzle and the second set of deflector surfaces configured to deflect fluid relatively close to the spray nozzle.

20. The spray nozzle of claim 17 wherein each corresponding upward and downward flow passage has at least one different cross-sectional dimension so that each corresponding upward and downward flow passage produces a different emission profile.
